(19) United States
(12) Patent Application Publication
(10) Pub. No.: US 2010/0300971 A1
(43) Pub. Date: Dec. 2, 2010

(54) Zwitterionic stationary phase as well as method for using and producing said phase

(75) Inventors: Wen Jiang, Umea (SE); Knut Irgum, Bullmark (SE)

Correspondence Address: MILLEN, WHITE, ZELANO & BRANIGAN, P.C., 2200 CLARENDON BLVD., SUITE 1400, ARLINGTON, VA, 22201, US

(73) Assignee: SeQuant AB, Umea (SE)

(21) Appl. No.: 11/435,280

(22) Filed: May 17, 2006

Related U.S. Application Data
(60) Provisional application No. 60/681,953, filed on May 18, 2005.

(51) Int. Cl. B01D 15/08; C07F 9/09; C08F 8/40

(52) U.S. Cl. 210/656; 210/198.2; 556/405; 556/24; 558/70; 525/340

(57) ABSTRACT

The present invention relates to a zwitterionic stationary phase comprising a carrier and at least one zwitterionic ligand bound to said carrier, said phase being suitable for HPLC separation in Hydrophilic Interaction mode, wherein the positively charged part of said zwitterionic ligand is located at the end of the ligand, and the negatively charged part of said zwitterionic ligand is located between the positively charged part and the part of said zwitterionic ligand directly binding to said carrier, or a polymeric backbone attached to the carrier, wherein the intramolecular distance between the negatively charged part of the zwitterionic ligand preferably is at most 10 atoms long. The invention also provides methods for producing said zwitterionic stationary phase and method for using the phase in HPLC separations.

The present invention relates to a novel zwitterionic stationary phase which is suitable for HPLC separations in general, and especially for separations in hydrophilic interaction mode. The invention also relates to methods for producing zwitterionic stationary phase as well as chromatographic separation methods involving the novel zwitterionic stationary phase.

### TECHNICAL BACKGROUND

Reversed-phase liquid chromatography (RP-HPLC) is the most common technique used in separation of peptides (Mant, C. T.; Hodges, R. S. In High Resolution Separation of Biological Macromolecules, Part B: Applications; Karger B. L.; Hancock, W. S., Eds.; (Meth. Enzymol. 271); Academic Press: San Diego, 1996; pp 3-50.). Although other separation techniques such as size-exclusion (SEC), ion-exchange (IEC), hydrophobic interaction (HIC), and immobilized metal-affinity chromatography (IMAC) can be used to fulfill the separations, compatibility with mass-spectrometry is a problem due to high salt concentrations in the eluents (Mant, C. T.; Hodges, R. S. In High Resolution Separation of Biological Macromolecules, Part B: Applications; Karger B. L.; Hancock, W. S., Eds.; (Meth. Enzymol. 271); Academic Press: San Diego, 1996; pp 3-50; Schlichtherle-Cerny, H.; Affolter, M.; Cerny, C. Anal. Chem. 2003, 75, 2349-2354). Generally, the chromatographic separation of small hydrophilic peptides by RP-HPLC is poor, because of low retention. A common way to enhance the separation in RP-HPLC is to derivatize the peptides for increased hydrophobicity (Zukowski, J.; Pawlowska, M.; Nagatkina, M.; Armstrong, D. W. J. Chromatogr. 1993, 629, 169-179; Roturier, J. M.; Lebars, D.; Gripon, J. C. J. Chromatogr. A 1995, 696, 209-217; Julka, S.; Regnier, F. E. Anal. Chem. 2004, 76, 5799-5806). However, derivatization is laborious and prone to introduce errors in the overall analytical scheme. Side reactions and slow kinetics at trace concentrations are also factors limiting the usefulness of derivatization schemes. Hydrophilic interaction liquid chromatography (HILIC) is a separation mode that addresses these problems. It is a variation of traditional normal phase chromatography, where the water immiscible solvents are replaced by water-miscible. The polar solutes are then retained in the highly polar surface layer of the stationary phase by hydrophilic interaction. The term HILIC was coined by Alpert in 1990 when he studied silicas with hydroxyethyl or sulfoethyl type hydrophilic functional groups (Alpert, A. J. J. Chromatogr. 1990, 499, 177-196). Since his pioneering work, several other materials have been developed specifically for HILIC applications (Strege, M. A. Anal. Chem. 1998, 70, 2439-2445; Yoshida, T. J. Biochem. Biophys. Meth. 2004, 60, 265-280; Churms, S. C. J. Chromatogr. A 1996, 720, 75-91; Liu, S. M.; Xu, L.; Wu, C. T.; Feng, Y. Q. Talanta 2004, 64, 929-934). In addition, materials with covalently bonded sulfoalkylbetaine type zwitterionic groups (Jiang, W.; Irgum, K. Anal. Chem. 1999, 71, 333-344; Jiang, W.; Irgum, K. Anal. Chem. 2001, 73, 1993-2003; Jiang, W.; Irgum, K. Anal. Chem. 2002, 74, 4682-4687) have been used in HILIC mode separations (Appelblad, P. LC GC Eur. 2003, April issue, Suppl. S, 25-26; Jonsson, T.; Appelblad, P. LC GC Eur. 2004, September issue, Suppl. S, 57-58; Appelblad, P.; Abrahamsson, P. LC GC Eur. 2005, March issue, Suppl. S, 47-48, Guo, Y., Gaiki, S., J. Chromatogr. A 2005, 1074, 71-80). These materials show good separation capability and a unique selectivity for many solutes, because the separation depends on both hydrophilic interaction and weak ionic interactions between the analyte and the zwitterionic functionalities.

Zwitterionic separation materials are characterized by carrying both positive and negative charges on the material surface (Nesterenko, P. N.; Haddad, P. R. Anal. Sci. 2000, 16, 565-574; Jiang, W. Zwitterionic Separation Materials for Liquid Chromatography and Capillary Electrophoresis, Thesis, Umeå University: Umeå, Sweden, 2003). Because the functional moieties contain two oppositely charged groups in close proximity at a stoichiometric ratio, the electrostatic interaction between the charged groups on the stationary phase and oppositely charged analytes is weaker compared to normal ion exchangers. Previous studies have shown that zwitterionic materials can be obtained through both covalent bonding and dynamic coating procedures, employing groups with different zwitterionic functionalities (Nesterenko, P. N.; Haddad, P. R. Anal. Sci. 2000, 16, 565-574; Jiang, W. Zwitterionic Separation Materials for Liquid Chromatography and Capillary Electrophoresis, Thesis, Umeå University: Umeå, Sweden, 2003; Hu, W. Z.; Haddad, P. R. TRAC-Trends Anal. Chem. 1998, 17, 73-79). In the choice between covalently bonded and dynamically coated materials, only covalently bonded zwitterionic surface layers are stable enough to withstand eluents with the high organic solvent admixtures that are necessary in HILIC mode. Several covalently bonded sulfoalkylbetaine type zwitterionic materials, possessing both positively charged quaternary ammonium and negatively charged sulfonic groups, have been synthesized by our group and others (Jiang, W.; Irgum, K. Anal. Chem. 1999, 71, 333-344; Jiang, W.; Irgum, K. Anal. Chem. 2001, 73, 1993-2003; Jiang, W.; Irgum, K. Anal. Chem. 2002, 74, 4682-4687; Viklund, C.; Irgum, K. Macromolecules 2000, 33, 2539-2544; Viklund, C.; Sjogren, A.; Irgum, K.; Nes, I. Anal. Chem. 2001, 73, 444-452; Yu, L. W.; Hartwick, R. A. J. Chromatogr. Sci. 1989, 27, 176-185; Arasawa, H.; Odawara, C.; Yokoyama, R.; Saitoh, H.; Yamauchi, T.; Tsubokawa, N. React. Funct. Polym. 2004, 61, 153-161; Tramposch, W. G.; Weber, S. G. J. Chromatogr. 1991, 544, 113-123). The applications of these materials varies from separation of small inorganic ions and organic molecules to biological macromolecules such as proteins, by the zwitterionic chromatographic (ZIC) and ion-exchange chromatographic (IEC) separation mechanisms. Additionally, bonded zwitterionic phases are suitable for HILIC owing to a highly hydrophilic polymer surface layer, as mentioned above. During development of the sulfoalkylbetaine type of zwitterionic stationary phases, they were found to possess a slight negative surface charge because of the spatial arrangement with the sulfonic group at the distal end of the zwitterionic moiety. Consequently, other separation material with different zwitterionic functionality and an opposite spatial charge orientation are interesting to study in the search for alternative selectivities. Moreover, it also turns out that the very low salt concentrations required for elution using such conventional zwitterionic stationary phases could be too high for very sensitive and complex molecules, such as certain proteins. Consequently, there is a need for new zwitterionic stationary phases which require still lower salt concentrations in order to achieve successful elutions and improvements with respect to detection.

### SUMMARY OF THE INVENTION

The objective problem underlying the present invention was solved by providing a zwitterionic stationary phase comprising a carrier and at least one zwitterionic ligand bound to said carrier, said phase being suitable for HPLC separation in Hydrophilic Interaction mode, wherein the positively charged part of said zwitterionic ligand is located at the end of the ligand, and the negatively charged part of said zwitterionic ligand is located between the positively charged part and the part of said zwitterionic ligand directly binding to said carrier, wherein the intramolecular distance between the negatively charged part of the zwitterionic ligand and the carrier preferably is at most 10 atoms long.

In a preferred embodiment, the zwitterionic ligand has been bound to said carrier by graft polymerization or by a multi-step reaction attachment of zwitterionic monomers or zwitterionic ligands onto the surface of said carrier. Suitable zwitterionic compounds that can be used in accordance with the present invention are compounds according to the general formula:

X—R₁—PO⁻₂—O—R₂—N⁺R₃R₄R₅

wherein
X is CH₂═C(CH₃)CO—O—, CH₂═CH—CO—O—, CH₂═C(CH₃)CO—N—, CH₂═CH—CO—N—, CH₂═CH— or CH₂═CH—C₆H₆—;
R₁ is (—CH₂—)ₙ where n is a positive integer and n<4;
R₂ is (—CH₂—)ₙ where n is a positive integer and n<4;
R₃, R₄ and R₅ are the same or different and are —(—CH₂)ₙ—Y where n<4 and Y is chosen from H and OH.

Preferred such zwitterionic monomers are 2-(methacryloyloxy)ethyl-2-(trimethylammonium)ethyl phosphate, 2-(methacryloyloxy)-2-[(dimetoxy)methylammonium]ethyl phosphate, 2-(methacryloyloxy)-2-(trimetoxyammonium)ethyl phosphate, 2-(methacryloyloxy)-2-[(2-hydroxyethyl)dimethylammonium]ethyl phosphate, 2-(methacryloyloxy)-2-[bis(2-hydroxyethyl)methylammonium]ethyl phosphate, 2-(methacryloyloxy)-2-[tris-(2-hydroxyethyl)ammonium]ethyl phosphate, 2-(p-methacryloyloxybenzoyloxy)ethyl-2-(trimethylammonium)ethyl phosphate, 2-(acryloyloxy)ethyl-2-(trimethylammonium)ethyl phosphate, p-vinylbenzyl-2-(trimethylammonium)ethyl phosphate, p-vinylbenzyl-2-(trimethoxyammonium)ethyl phosphate, p-vinylbenzyl-2-[tris-(2-hydroxyethyl)ammonium]ethyl phosphate.

Examples of carriers that are suitable in connection with the present invention are porous silica, zirconium, graphite, and polymer or copolymer materials in the shape of spherical particles having a size ranging from 0.1 to 100 μm and a porosity from 50 to 1000 Å, or a monolithic structure of said materials, or the inner-wall of narrow bore fused silica capillaries.

The polymer or copolymer of synthetic or natural origin may comprise mono- or oligovinyl monomer units such as styrene and its substituted derivatives, acrylic acid or methacrylic acid, alkyl acrylates and methacrylates, hydroxyalkyl acrylates and methacrylates, acrylamides and methacrylamides, vinylpyridine and its substituted derivatives, divinylbenzene, divinylpyridine, alkylene diacrylate, alkylene dimethacrylate, oligoethylene glycol diacrylate and oligoethylene glycol dimethacrylate with up to 5 ethylene glycol repeat units, alkylene bis(acrylamides), piperidine bis(acrylamide), trimethylolpropane triacrylate, trimethylolpropane trimethacrylate, pentaerythriol triacrylate and tetraacrylate, and mixture thereof.

In another embodiment, the invention provides a method for preparing a zwitterionic stationary phase, comprising the steps of:

a) providing a carrier, such as a porous silica particle or a porous monolithic particle;
b) providing a zwitterionic monomer containing a phosphorylcholine zwitterionic functionality, such as 2-methacryloyloxyethyl phosphorylcholine;
c) optionally activating the surface of said carrier;
d) optionally providing a polymerization catalyst;
e) contacting said optionally activated carrier, said zwitterionic monomer, and optionally said catalyst, thereby initiating a polymerization process on the surface of said carrier; and thereby
f) obtaining said zwitterionic stationary phase.

In yet another embodiment, the inventions relates to using said zwitterionic stationary phase in different HPLC separation methods, and in particular in the hydrophilic interaction mode.

The phosphorylcholine (PC) zwitterionic functionality was chosen as a preferred functionality, since it possesses both a positively charged quaternary ammonium groups and a negatively charged phosphoric group, with opposite charge arrangement compared to the sulfoalkylbetaine type materials. The use of PC type functionality as such is not new in chromatography, since immobilized phospholipids and liposomes have already been studied over the last 25 years (Wiedmer, S. K.; Jussila, M. S.; Riekkola, M. L. Trac-Trends in Anal. Chem. 2004, 23, 562-582). One of the most important techniques in this area, Immobilized Artificial Membrane Chromatography (IAMC), was invented by Pidgeon et al. in 1989 (Pidgeon, C.; Venkataram, U. V. Anal. Biochem. 1989, 176, 36-47). The IAMC materials normally contain PC type zwitterionic or other ionic groups covalent bonded to aminopropyl silica through a long chain alkyl linkage. These materials are mainly used for the purpose to study drug permeability through phospholipids membranes due to a mimicry of natural biological membranes and these phases also show high affinity for hydrophobic membrane proteins (Yang, C. Y.; Cai, S. J.; Liu, H. L.; Pidgeon, C. Adv. Drug Deliv. Rev. 1996, 23, 229-256; Taillardat-Bertschinger, A.; Carrupt, P. A.; Barbato, F.; Testa, B. J. Med. Chem. 2003, 46, 655-665. However, the long non-polar alkyl chain in these materials is undesirable for HILIC separation phases, where the separation mechanism require that the phase is very hydrophilic. From our experience with synthesis of covalently bonded sulfoalkylbetaine type zwitterionic separation materials, graft polymerization of methacrylate-based zwitterionic monomers initiated by surface-tethered initiators has proven to be a simple and efficient way to accomplish materials with a sufficient functional group density to act as HILIC sorbents. Material produced in this manner has reasonable surface coverage and very good charge balance of the zwitterionic groups (Jiang, W.; Irgum, K. Anal. Chem. 2002, 74, 4682-4687). Many PC type zwitterionic monomers have been synthesized and studied in the last two decades, yet the applications were mostly focused on preparing biocompatible materials (Nakaya, T.; Li, Y. J. Progr. Polym. Sci. 1999, 24, 143-181; Nakaya, T.; Li, Y. J. Des. Monomers Polym. 2003, 6, 309-351; Iwasaki, Y.; Ishihara, K. Anal. Bioanal. Chem. 2005, 381, 534-546).

Accordingly, a new type of HILIC separation material with a phosphorylcholine type zwitterionic layer was synthesized by attachment of the zwitterionic monomer 2-methacryloyloxyethyl phosphorylcholine (MPC). The material was characterized by NMR, FT-IR, elemental analysis, and by ζ-potential measurements. Peptides were used as test probes to investigate its chromatographic behavior in HILIC separation mode, and the separation properties of the MPC grafted silica was compared with the native silica used as substrate.

### BRIEF DESCRIPTION OF THE FIGURES

The present invention will now be described with reference to the enclosed figures, in which:

Scheme 1 discloses synthesis steps used for preparing the zwitterionic stationary phase KS-polyMPC.

FIG. 1 shows solid state ¹³C NMR Spectra of the silica after graft polymerization of MPC.

FIG. 2 relates to chromatogram from the separation of six peptides mixture on the KS-polyMPC zwitterionic column. Eluent: 60/40 (v/v) acetonitrile/10 mM ammonium acetate, pH 6; flow rate: 1 mL/min; UV detection: 214 nm.

FIG. 3 discloses calculated titration curves for the peptides used as test probes in the chromatographic runs.

FIG. 4 reveals effect of pH of the buffer used to make up the eluent on the retention of six peptides on: A) KS-polyMPC; B) native silica. Eluent: 60/40 acetonitrile/10 mM ammonium acetate (pH 5, 6 and 7) or ammonium formate (pH 3 and 4) buffer; flow rate: 1 mL/min; UV detection: 214 nm.

FIG. 5 describes effect of concentration of the buffer used to make up the eluent on the retention of six peptides on: A) KS-polyMPC; B) native silica. Eluent: 60/40 acetonitrile/ammonium acetate, pH 6; flow rate: 1 mL/min; UV detection: 214 nm.

FIG. 6 shows effect of acetonitrile concentration in eluent on the retention of six peptides on KS-polyMPC. Eluent: acetonitrile/10 mM ammonium acetate, pH 7; flow rate: 1 mL/min; UV detection: 214 nm.

FIG. 7 discloses chromatogram from the separation of three angiotensin peptides on KS-polyMPC. Eluent: 75/25 acetonitrile/50 mM ammonium acetate buffer, pH 7; flow rate: 1 mL/min; UV detection: 214 nm.

FIG. 8 describes effect of pH of the buffer used to make up the eluent on the retention of six peptides on: A) KS-polyMPC; B) ZIC®-HILIC column. Eluent: 60/40 acetonitrile/10 mM ammonium acetate or formiate; flow rate: 1 mL/min; UV detection: 214 nm.

FIG. 9 describes effect of concentration of the buffer used to make up the eluent on the retention of six peptides on: A) KS-polyMPC; B) ZIC®-HILIC column. Eluent: 60/40 acetonitrile/ammonium acetate; pH 6, flow rate: 1 mL/min; UV detection: 214 nm.

FIG. 10 discloses chromatograms from the separation of three peptides mixture on A) KS-polyMPC, eluent: 60/40 (v/v) acetonitrile/10 mM ammonium acetate, pH 7; B) Kromasil C18, eluent: 5/95 acetonitrile/10 mM ammonium acetate, pH 7. Flow rate: 1 mL/min; UV detection: 214 nm.

### EXPERIMENTAL PART

### Materials and Methods

Reagents and Chemicals. Kromasil® spherical silica particles (5 μm particle size; 200 Å pore size) were obtained from EKA Chemicals (Bohus, Sweden). Thionyl chloride (99%), tert-butyl hydroperoxide (5 M in octane), 2-hydroxyethyl methacrylate (HEMA; >99%), Ethylene chlorophosphate (COP; 95%) and trimethylamine (TMA; >99%) were purchased from Fluka (Buchs, Switzerland). Acetonitrile and methanol (HPLC grade) were from J. T. Baker (Deventeer, Holland). Triethylamine (TEA; >99%), toluene and acetone (GC grade) were from Merck (Darmstadt, Germany). FOS-Choline®-12 detergent and 2-methacryloyloxyethyl phosphorylcholine (MPC) were obtained from Anatrace Inc. (Maumee, Ohio) and Biocompatibles (Farnham, UK), respectively. Water was purified by a Ultra-Q water purification system (Millipore, Bedford, Mass.).

Peptides used as test probes were purchased from Sigma (St. Louis, Mo.) and Fluka (Buchs, Switzerland), and were the following (product number): Gly-Gly-Gly (GGG, G1377); Gly-Gly-His (GGH, G4541); Leu-Gly-Gly (LGG, 61990); Phe-Gly-Gly-Phe (FGGF, P3626); neurotensin (ELYENKPRRPYIL, N6383); bradykinin (RPPGFSPFR, B3259); angiotensin I human (DRVYIHPFHL, A9650); angiotensin II human (DRVYIHPF, A9525); angiotensin III (RVYIHPF, 10385). All purchased peptides were stored according to the manufacturer's recommendations and used as received to prepare sample solutions for injection. The final test sample solutions contained 0.25 mg/ml of each peptide in 60/40 acetonitrile/water solution except for FGGF, where the concentration was 0.1 mg/mL.

Synthesis and Characterization of MPC. The MPC monomer was first synthesized according to the literature (Ishihara, K.; Ueda, T.; Nakabayashi, N. Polym. J (Tokyo) 1990, 22, 355-360; Driver, M. J.; Jackson, D. J.; (Biocompatibles, UK) a) PCT WO95/14702, 1995; b) U.S. Pat. No. 5,741,923, 1998) and checked by ¹H NMR and FT-IR. ¹H NMR (400 MHz) (CDCl₃): δ=1.91 (—CH₃, 3H), δ=3.38 (—N(CH₃)₃, 9H), δ=3.81-3.82 (—CH₂N, 2H), δ=4.06-4.09 (POCH₂—, 2H), δ=4.30-4.32 (OCH₂—CH₂OP, 4H), δ=5.55-5.59 (CH₂═, 1H) and δ=6.10 ppm (CH═, 1H). FT-IR: 1730 (C═O), 1638 (C═C), 1240 (P═O), 1080 (—POCH₂—) and 970 cm⁻¹ (N⁺(CH₃)₃). According to the ¹H NMR spectra, the ratio of the signals from the quaternary ammonium group methyl group protons (δ=3.38 ppm) and the hydrogen at the tertiary carbon of the methacrylate group (δ=6.10 ppm) showed that the synthesized monomer had a purity of about 97%. This MPC monomer had ¹H NMR and FT-IR spectra almost identical to those of the MPC obtained from Biocompatibles, and both monomer batches were used in the syntheses.

### Synthesis and Characterization of the Zwitterionic Stationary Phase KS-polyMPC.

Activation and graft polymerization of silica were in accordance to Jiang, W.; Irgum, K. Anal. Chem. 2002, 74, 4682-4687, with minor upscaling changes. In another approach the zwitterionic moiety was introduced by a multi-step synthetic route based on ethylene chlorophosphate reaction. The phosphorus and nitrogen contents of the intermediates and the final material were determined by elemental analysis at MikroKemi AB (Uppsala, Sweden) using validated methods. Infrared spectra were obtained on pressed tablets of ground KBr/silica, using an ATI Mattson (Thermo Electron Corp., Woburn, Mass.) Genesis Series FT-IR instrument.

The ¹³C CP/MAS NMR spectra were recorded on a Bruker (Billerica, Mass.) ASX 300 NMR Spectrometer (300 MHz, 7.05 T) at a spinning rate of 10 kHz with 4 mm double bearing rotors of ZrO₂. The proton 90° pulse length was 3.5 μs and the temperature 295 K. The spectra were obtained with a cross-polarization contact time of 2 ms and the pulse intervals was 2 s. Glycine was used as a reference, and to adjust the Hartmann-Hahn condition. The ²⁹Si CP/MAS NMR spectra were recorded at a spinning rate of 4 kHz with 7 mm double bearing rotors of ZrO₂. The proton 90° pulse length was 3.5 μs and the temperature 295 K. The spectra were obtained with a cross-polarization contact time of 5 ms and the pulse interval was 1 s. Adamantan was used as a reference, and to adjust the Hartmann-Hahn condition.

Measurement of Zeta-potential. The ζ-potential measurements were carried out by photon correlation spectroscopy using a Zetasizer 4 instrument (Malvern, U.K.). Stock sample solutions were prepared by suspending 50 mg material in 30 mL of water. The final samples for ζ-potential measurement were prepared by mixing 1 mL stock sample with buffer (depending on final concentration), and then diluted with water to 10 ml. After a solution was made, it was thoroughly mixed on a Heidolph (Schwabach, Germany) REAX Control vortex mixer and immediately thereafter transferred to the measurement cell. The ζ-potential measurement on the Nucleosil C₁₈ coated with FOS-Choline®-12 was done in the same way as described in Jiang, W.; Irgum, K. Anal. Chem. 2002, 74, 4682-4687, where sulfoalkylbetaine type zwitterionic detergent SB12 was used.

Chromatographic Evaluation. Both native silica particles and the KS-polyMPC were slurry packed into 150 mm by 4.6 mm i.d. poly(ether-ether-ketone) (PEEK) column blanks from Isolation Technologies (Hopedale, Mass.), by a pneumatic amplifier type pump (Knauer, Berlin, Germany).

The chromatographic system consisted of a 2250 HPLC Compact Pump, a Lambda 1010 UV-Vis detector with 3 mm optical path (both from Bischoff, Leonberg, Germany) and an AS 3000 autosampler with 20 μl PEEK injection loop (Spectra-Physics). All chromatograms were recorded on a PC computer with Star workstation software (Varian, Palo Alto, Calif.). The chromatographic evaluations were carried out at room temperature (22±2° C.).

Estimation of Peptide Properties. pI values and protein titration curves were calculated on the Internet site L'Atelier BioInformatique de Marseille (http://www.up.univ-mrs.fr/wabim) using values from Sillero and Ribeiro (Sillero A.; Ribeiro J. M. Anal. Biochem. 1989, 179, 319-325) available at that site as input pKₐ values for His, Asp, Lys, Glu, Arg, Tyr, Cys, and the terminal —NH₂ and —COOH groups. The grand average of hydropathicity (GRAVY) score was calculated by the ProtParam Tool of the ExPASy (Expert Protein Analysis System) proteomics server of the Swiss Institute of Bioinformatics (SIB) (ExPASy Proteomics Server, http://www.expasy.org/tools/protparam.html), where the hydropathicity scale values by Kyte and Doolittle (Kyte, J.; Doolittle, R. F. J. Mol. Biol. 1982, 157, 105-132) are used to compute GRAVY from the amino acid sequences. Peptide retention coefficients in normal phase separation were calculated using the method and hydrophilicity retention coefficients of Yoshida (Yoshida, T. J. Chromatogr. A 1998, 808, 105-112).

### Example 1

### Synthesis and Characterization of the Zwitterionic Stationary Phase KS-polyMPC

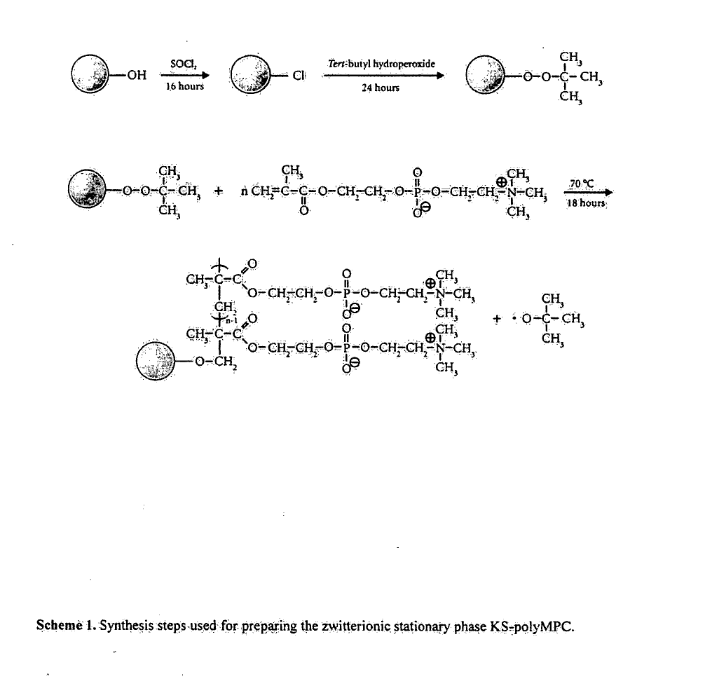

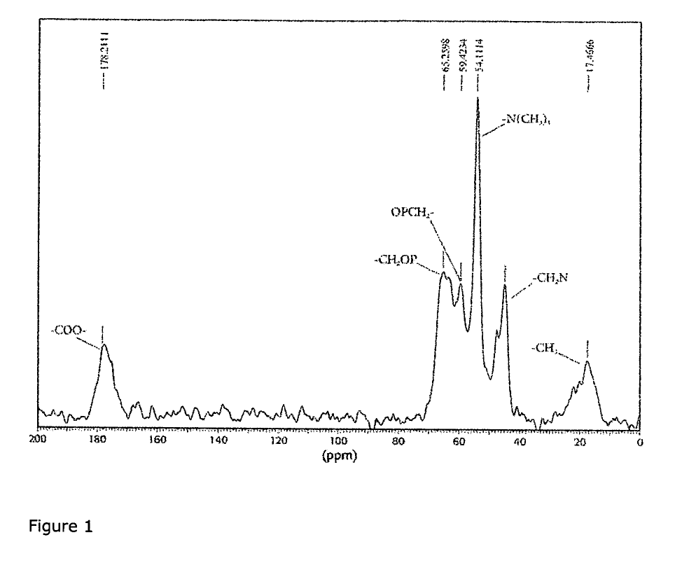

Scheme 1 shows the schematic procedures used in the synthesis of the KS-polyMPC zwitterionic separation material. As was discussed previously (Jiang, W.; Irgum, K. Anal. Chem. 2002, 74, 4682-4687), porous silica particles were activated to achieve peroxide groups on the material surface, used as intiator sites for subsequent graft polymerization of zwitterionic monomer. This method was chosen because it ascertains that the graft polymerization starts form the particle surface, as opposed to homogeneous intiation, where polymers initiated in solution loop past vinylic groups on the surface. The nitrogen and phosphorus contents were analyzed by elemental analysis. The phosphorus to nitrogen molar ratio was found to be between 1.00 and 1.12. This means the grafted MPC zwitterionic material had a charge balance close to unity. The materials were also analyzed by FT-IR, but the area of most important information was overlapped with the signals from native silica in the range of 900-1400 cm⁻¹. ²⁹Si CP/MAS NMR spectra of the native silica and the KS-polyMPC material showed that the —O—Si(O₂)—O— groups (−111 ppm) remained unchanged, whereas the —Si(OH)₂ (−92 ppm) and —SiOH (−101 ppm) groups decreased after the graft polymerization. This reduction of free silanol groups indicates a successful covalent modification of the silica surface. In order to obtain more information on the structure of the attached polymer, ¹³C CP/MAS was further studied on the MPC grafted material, with spectrum shown in FIG. 1. All signals can be assigned to groups present in the expected MPC polymer and are in accordance with Ishihara et al (Ishihara, K.; Ueda, T.; Nakabayashi, N. Polym. J. (Tokyo) 1990, 22, 355-360).

The surface charge properties in aqueous solution were studied by particle electrophoresis in a Zetasizer photon correlation spectrometer. The ζ-potential of native silica and KS-polyMPC were measured in 20 mM ammonium acetate buffer at five different pH levels (pH 3, 4, 5, 6 and 7). The results of these measurements are presented in Table 1.

TABLE 1
Results from the □-potential measurements on the native
silica KS and the zwitterionic material KS-polyMPC.

| pH | 3 | 4 | 5 | 6 | 7 |
|---|---|---|---|---|---|
| KS | −1.6 ± 0.5 | −3.9 ± 0.1 | −5.9 ± 0.1 | −11.7 ± 0.3 | −16.7 ± 1.1 |
| KS-polyMPC | −5.2 ± 0.3 | −7.0 ± 0.3 | −6.8 ± 0.5 | −10.8 ± 0.1 | −12.5 ± 0.4 |

It was found that the absolute values of the ζ-potential increased with increasing pH of the buffer solution on both materials. However, the increase for the KS-polyMPC material was less steep than that of the native silica material. In addition, the KS-polyMPC generally had lower absolute ζ-potential values. From the hypothesis of this study, it was thought the net surface charge would be positive because of the opposite spatial arrangement of the ionic groups in the MPC zwitterionic moiety as compared to the previously studies on sulfoalkylbetaine materials. However, the MPC material showed a slight negative surface charge in all the ζ-potential measurement. By searching the literature, similar ζ-potential data can be found in studies of silica coated with double-tailed phosphorylcholine surfactant through a two-step procedure process (Katagiri, K.; Hashizume, M.; Kikuchi, J.; Taketani, Y.; Murakami, M. Colloids Surf., B 2004, 38, 149-153). In another study by Kamimori et al., it is shown that phospholipid coated columns have a large decrease in retention of anions at pH above 2 (Kamimori, H.; Konishi, M. Biomed. Chromatogr. 2002, 16, 61-67). This is attributed to dissociation of the phosphoric acid group, which has pKₐ of approx. 2-3. Moreover, ζ-potentials of 3 μm Nucleosil C₁₈ coated with FOS-Choline®-12 and measured this work were −4.9±1.4, −9.7±0.3, and −1.4±0.9 mV in Ultra-Q water, 2 mM NaCl, and 20 mM NaCl, respectively.

The ζ-potential measurements were also attempted in 4 mM buffer concentration, but the results showed much larger variation compared to those at higher buffer concentration. This may have been induced by aggregation or settling of the particles in the photo-correlation measurements.

### Example 2

### Separation of Peptides by HILIC

Six peptides were chosen as test probes for studies of the hydrophilic interaction chromatographic properties of KS-polyMPC column. Of these peptides, four had two glycines in peptide chain (FGGF, LGG, GGG, and GGH). FGGF has two hydrophobic phenylalanine residues in each terminal, making it most hydrophobic among these four peptides. GGH has a histidine group in the carboxyl terminal and is the most hydrophilic member of the test set. Neurotensin and bradykinin are both hydrophilic peptides with 13 and 9 residues, respectively. Table 2 lists the pI values, hydropathicity scale (GRAVY score) and estimated hydrophilic retention coefficients of the peptides used in this study.

TABLE 2
pI, hydrophobic scale and hydrophilicity retention
coefficients of peptides used as test probes.

| | | | | Hydrophilicity | |
|---|---|---|---|---|---|
| | | | | Retention | HILIC Mode |
| Peptide | Sequence | pI^{a)} | GRAVY^{b)} | Coefficient^{c)} | Retention^{d)} |
| Phe-Gly-Gly- | FGGF | 5.70 | 1.200 | 6.70 | 0.38 |
| Phe | | | | | |
| Leu-Gly-Gly | LGG | 5.70 | 1.000 | 10.27 | 0.90 |
| Gly-Gly-Gly | GGG | 5.70 | −0.400 | 12.42 | 19.5 |
| Gly-Gly-His | GGH | 7.30 | −1.333 | 16.02 | 28.5 |
| Neurotensin | ELYENKPRRPYIL | 8.95 | −1.315 | 25.24 | 34.7 |
| Bradykinin | RPPGFSPFR | 12.00 | −1.044 | 19.50 | 17.8 |
| Angiotensin | DRVYIHPFHL | 7.45 | −0.200 | 18.01 | N/A |
| I | | | | | |
| Angiotensin | DRVYIHPF | 7.30 | −0.325 | 16.88 | N/A |
| II | | | | | |
| Angiotensin | RVYIHPF | 9.10 | 0.129 | 14.43 | N/A |
| III | | | | | |

^{a)}Calculated on L'Atelier BioInformatique de Marseille (http://www.up.univmrs.fr/wabim), using dissociation constants by Sillero and Ribeiro (Sillero A.; Ribeiro J. M. Anal. Biochem. 1989, 179, 319-325);
^{b)}GRAVY (grand average of hydropathicity) was calculated by the ExPASy ProtParam tool (ExPASy Proteomics Server, (http://www.expasy.org/tools/protparam.html) (see text);
^{c)}Calculated according to Yoshida (Yoshida, T. J. Chromatogr. A 1998, 808, 105-112);
^{d)}Retention factor on KS-polyMPC using 80/20 (v/v) acetonitrile/50 mM ammonium acetate, pH 6 as eluent; N/A, not available.

The chosen peptides vary from slightly acidic to very basic, which will help in exploring the ionic interaction between the stationary phase and analyte.

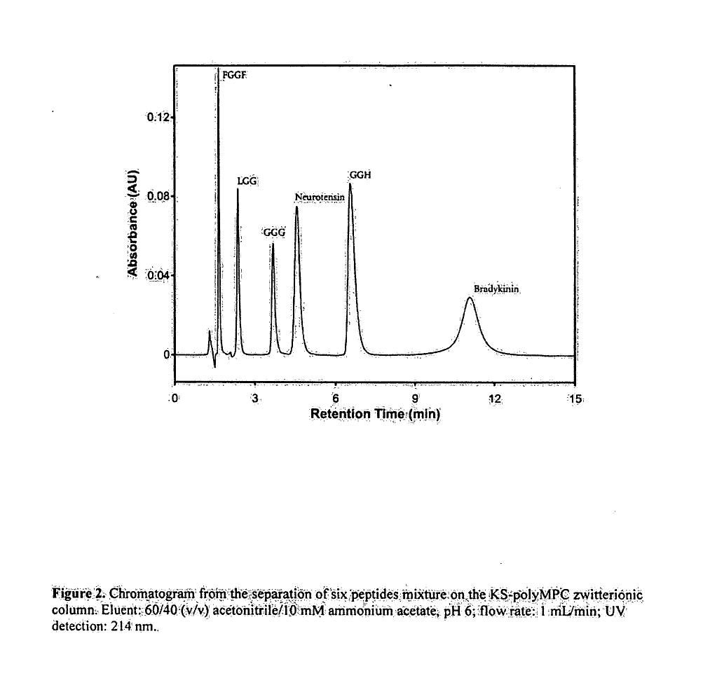

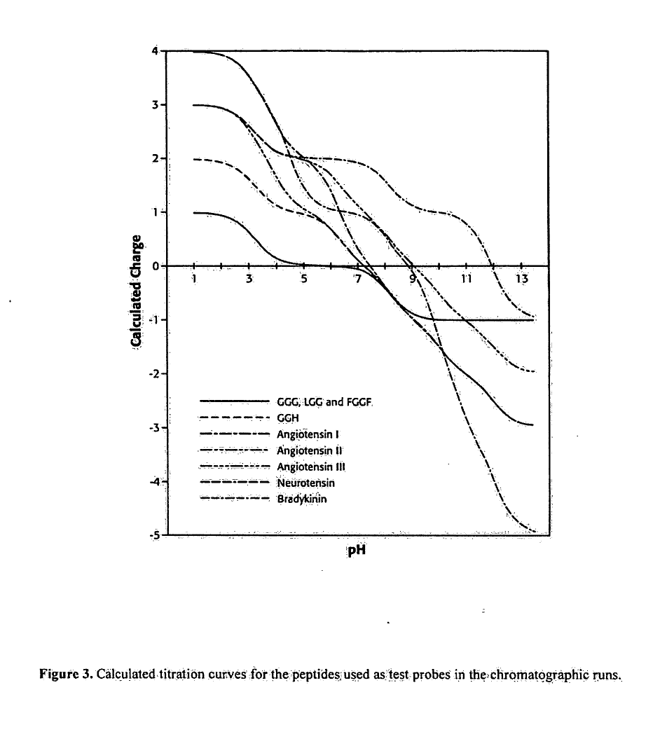

FIG. 2 is a chromatogram from an isocratic separation of six peptides by HILIC on the KS-polyMPC column, using 60/40 (v/v) acetonitrile/10 mM ammonium acetate, pH 6 as eluent. The first four peaks are FGGF, LGG, GGG and GGH, respectively, and their retentions follow the order of the GRAVY score and the estimated total hydrophilicity retention coefficient of peptides in normal phase separation. They also fit the hydrophobicity scale calculated according to Guo et al (Guo, D. C.; Mant, C. T.; Taneja, A. K.; Parker, J. M. R.; Hodges, R. S. J. Chromatogr. 1986, 359, 499-517). Since FGGF, LGG and GGG have the same estimated pI of 5.70, originating from the terminal amino and carboxy groups. According to the titration curves in FIG. 3, the change in charge is shallow around pI and the overall ionic interaction between the stationary phase and these peptides in the vicinity of their pI should therefore be similar and low. Thus, hydrophilic interaction will dominate their separation by HILIC. Low ionic interaction was seen for GGH under the tested condition, because of its slight positive charge induced by the His residue, cf. FIG. 3. The KS-polyMPC stationary phase thus expresses signs of a weak negative charge at pH 6, consistent with the ζ-potential measurements in Table 1. Neurotensin and bradykinin had very strong ionic interactions. These peptides are also quite basic (estimated pI 8.95 and 12.00), so their retentions seem to be based on a mix of hydrophilic interaction and ionic interaction in the tested ionic strength range. As seen in FIG. 2, neurotensin had a shorter retention time compared to GGH, in spite of an estimated higher hydrophilic retention according to the hydrophilicity coefficient. Explanations for this deviation from the predicted retention may be interaction between the terminal His residue and residual negative charges on the silica substrate, where the smaller GGH probe will experience a lower size-exclusion effect when the organic solvent is at a relatively low level. Solvent-induced conformation changes in the non-crosslinked graft layer is also a possible explanation. In the following discussion on the effect of acetonitrile concentration, the retention of neurotensin showed a much higher sensitivity than GGH to changes in the acetonitrile concentration when the admixture was increased to 70% and above. A similar sensitivity to solvent strength was not seen on native silica, where neurotensin had higher retention than GGH under all tested conditions. This indicates that the separation of peptides was mainly controlled by ionic interaction and to a lesser extent by hydrophilic interaction on the plain silica column.

Larger peptides should have higher sensitivity to solvent strength changes, according to the empirically observed retention vs. solvent admixture relationship in chromatography (Hearn, M. T. W. In HPLC of Peptides and Proteins: Separation, Analysis and Conformation; Mant, C. T.; Hodges, R. S., Eds.; CRC Press: Boca Raton, 1991; pp 105-122):

$$log k = A + B ( log \frac{1}{c} ) \qquad [ 1 ]$$

The grafted MPC phase thus appears to have a larger number of interaction points than native silica. This translates into better possibilities of modeling the selectivity, which is evident from the non-monotonic changes in retention vs. acetonitrile concentration on KS-polyMPC, as discussed below.

### Example 3

### Effect of Buffer pH

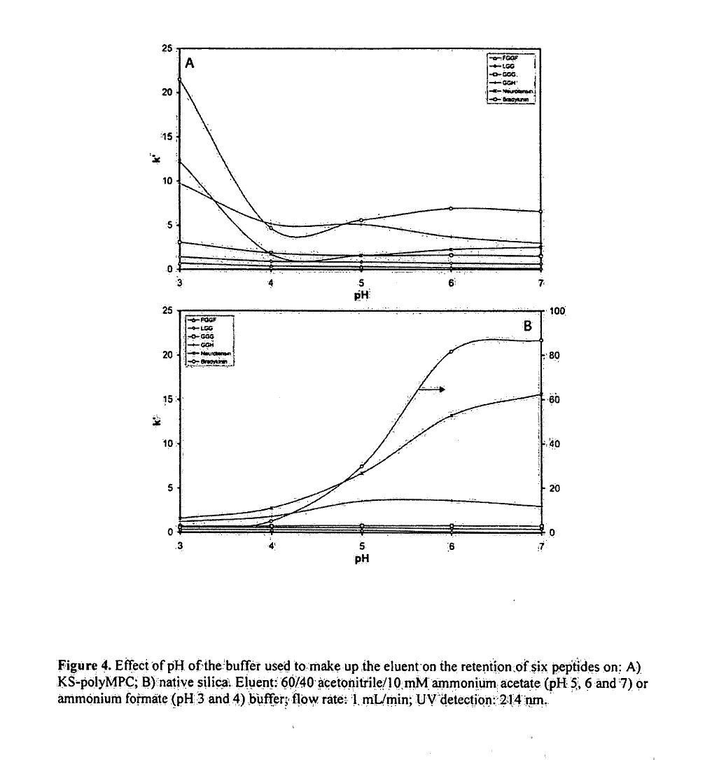

Peptides are amphoteric molecules whose charges change with pH of the surrounding medium. Their net charge is zero at pH=pI and increases with decreasing pH of buffer solution and vice versa, owing to protonation and dissociation of weakly basic and acidic side chains of the peptide, and of the amino and carboxy terminals. The retention factors (k) on both KS-polyMPC and on native Kromasil silica are shown in FIG. 4 as a function of the pH of the buffers used for mixing the eluents, maintaining the acetonitrile admixture and buffer concentration constant. These retention data can then be correlated with the estimated pH-dependent charge of the peptides shown in FIG. 3. As can be seen in FIG. 4A, the retention factors of the small peptides with identical pI (due to the terminals only), FGGF, LGG, and GGG, decreased slightly when pH was increased from 3 to 7 on the KS-polyMPC column. We attribute this to an increased positive charge accompanied by an increase the hydrophilicity of the peptides at lower pH, which translates into increased retention factors in the HILIC separation mode. A corresponding dependence has been found by Guo et al., i.e., that the positive charge at lower pH results in less retention of peptides in RP-HPLC (Guo, D. C.; Mant, C. T.; Taneja, A. K.; Parker, J. M. R.; Hodges, R. S. J. Chromatogr. 1986, 359, 499-517). On the other hand, weak ionic interaction may not be ruled out at lower pH, because FGGF, GGG, and LGG will be slightly positive and the KS-polyMPC material is still slightly negative at the lowest pH tested (cf. Table 1). The retention factors of GGH, neurotensin, and bradykinin all showed marked increases as the pH was decreased from pH 4 to 3, this effect being most pronounced for the larger peptides neurotensin and bradykinin. In this pH range, all the tested peptides undergo charge changes due to protonation of the terminal carboxyl group. Part of the retention could therefore be suspected to be due to interaction of the protonated amino terminal with residual unreacted silanols, as the peptide attains a higher net positive charge. However, if this would be the case, we should have expected at least a corresponding retention increase between pH 4 and 3 for GGG, the least sterically hindered of the peptides tested. An increase was seen, but not in the same order as for GGH and the larger peptides in the test set. We tentatively attribute this steep response in retention between pH 4 and 3 to be due mainly to changes in ionic interaction because of the protonation of the terminal carboxyl group, in combination with an increased hydrophilicity due to the increased positive charge. On the other hand, neurotensin and bradykinin showed lower retention at pH 4 compared to pH 5-7. This may result from mixed effects of a decreased charge of stationary phase and increased charge of peptide, resulting in lower net ionic interaction at this pH, but more likely due to the change of buffer salt from ammonium formate to acetate which took place between pH 5 and 4.

On native silica (FIG. 4B), the retention factors of the GGG/LGG/FGGF test set adhered to the same pH-dependence and elution order as with the KS-polyMPC column, but the retentions were constantly lower by a factor of approximately four under identical conditions. GGH showed a somewhat higher and weakly pH-dependent retention, ascribed to the His group. For neurotensin and bradykinin, the retention increased strongly with pH, in particular above pH 5, with k of bradykinin leveling off to k˜85 at neutral conditions. This indicates a very strong contribution from ionic interaction between dissociated silanol groups on the silica stationary phase and these two peptides, which are both positively charged in this pH range. The ζ-potential data in Table 1 also support these findings. When compared to the KS-polyMPC material, the neutral and basic peptides showed less stable retention and required longer run times, due to the difficulties of establishing a stable surface charge on a native silica stationary phase.

### Example 4

### Effect of Buffer Concentration in Eluent

In chromatographic separations based on ionic interactions, a decrease in retention is normally seen as the salt concentration in the eluent is increased. This has been studied by Kopaciewicz et al. in aqueous solutions, who found that log k vs. log [eluent concentration] describes linear relationships with slopes whose absolute values are equal to the quotient of the charges of the eluite ion and the counter-ion involved in the elution process (Kopaciewicz, W.; Rounds, M. A.; Fausnaugh, J.; Regnier, F. E. J. Chromatogr. 1983, 266, 3-21). Despite the use of a high content of organic modifier in the experiments, and that the separation was influenced by both ionic interaction and hydrophilic interaction, curves according to Kopaciewicz et al. were plotted (not shown). The slopes were low and it was therefore difficult to assess the exact magnitude of the ionic interaction. This was expected, since the measurements were made over an ionic strength range where the primary retention mechanism is expected to changes from ionic interaction to hydrophilic interaction.

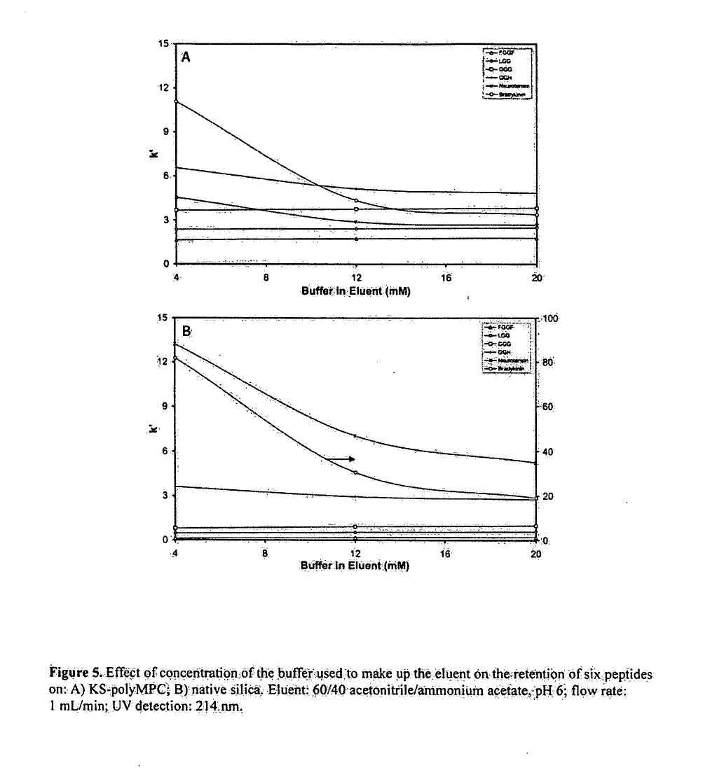

FIG. 5 shows the retention factors from isocratic separations of six peptides on the KS-polyMPC and native silica column under different buffer concentrations. As discussed above, FGGF, LGG and GGG all have estimated pI of 5.70 with shallow titration curves in the vicinity of the pI. The zwitterionic forms are therefore their dominant species at pH 6. Their retention factors were largely unaffected by ionic strength, and only slight increases were seen in retention at the lower end of the tested ion strength range, on both native silica and the KS-polyMPC column. This is indicative of very low ionic interaction and a retention that is mainly based on hydrophilic interaction. As in the pH tests above, the retention factors of FGGF, LGG, and GGG were higher on the KS-polyMPC material than on native silica under all tested buffer concentrations. This demonstartes that the KS-polyMPC had a higher retentive capability than native silica when the contribution from ionic interaction was largely eliminated. The retention of neurotensin and bradykinin decreased distinctly on both native silica and KS-polyMPC as the buffer concentration in the eluent was increased from 4 to 20 mM. The retention change on the native silica was again much larger than on the KS-polyMPC material, which points at a stronger ionic interaction for silica under the tested conditions. Higher buffer concentrations shield the ionic charges of the analytes and suppress the surface charge (ζ-potential) of stationary phase due to compression of the double layer (Landers, J. P., Ed. Handbook of Capillary Electrophoresis, 2^{nd} Ed., CRC Press: Boca Raton, 1997). Consequently, were therefore carried out additional ζ-potential measurements on the KS-polyMPC material in the ammonium acetate buffer, pH 6 at varying concentrations. The ζ-potentials found were −16.1±1.1, −13.4±0.5, −10.4±0.8, and −8.7±0.6 mV at 4, 12, 20 and 50 mM, respectively.

### Example 5

### Effect of Acetonitrile Concentration in Eluent

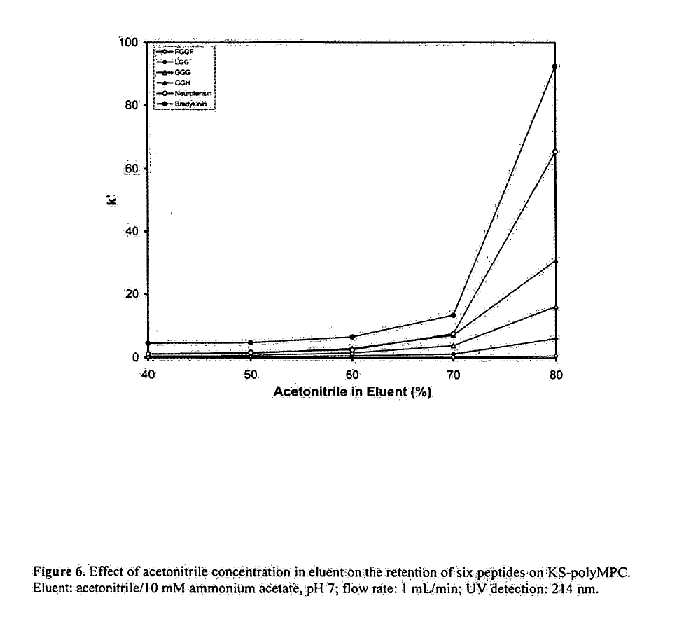

The amount of organic solvent in the eluent will strongly affect the retention time of polar compounds, because hydrophilic interaction is enhanced by decreasing the polarity of the eluent. As can be seen from FIG. 6, the general tendency is an increase in retention factor and resolution of all tested peptides with increased admixture of acetonitrile in the eluent, with the most substantial increase in retention taking place at acetonitrile concentrations above 70%. This is in accordance with findings on peptide separations by HILIC (Alpert, A. J. J. Chromatogr. 1990, 499, 177-196; Zhu, B. Y.; Mant, C. T.; Hodges, R. S. J. Chromatogr. 1992, 594, 75-86; Yoshida, T. Anal. Chem. 1997, 69, 3038-3043). We also found that the retention factor of the most hydrophobic peptide, Phe-Gly-Gly-Phe, showed only a minor increase in the range of 40% to 80% acetonitrile, owing to its low hydrophilicity.

As is deduced from the above discussions, the HILIC separation of peptides with 80% of acetonitrile and 2 mM buffer will involve ionic interaction, hydrophilic interaction, and to some extent size-exclusion. An extra experiment was thus carried out by increasing the buffer concentration used with the KS-polyMPC column at pH 6 from 2 to 10 mM, which will largely shield the ionic interactions between the stationary phase and analyte, as indicated in FIG. 5. The chromatograms (not included) showed that the retention order changed to neurotensin>GGH>GGG>bradykinin>LGG>FGGF, compared to the retention order bradykinin>neurotensin>GGH>GGG>LGG>FGGF with 2 mM buffer in the eluent. Size-exclusion or conformational effects in the linear graft layer may be involved in the separation because bradykinin had a shorter retention time compared to GGG, in spite of being more hydrophilic, see Table 2. A similar behavior was found for neurotensin, which showed less retention than GGH when the acetonitrile admixture was below 70%, despite neurotensin having higher pI and hydrophilicity than GGH.

### Example 6

### Simultaneous Separation of Angiotensins

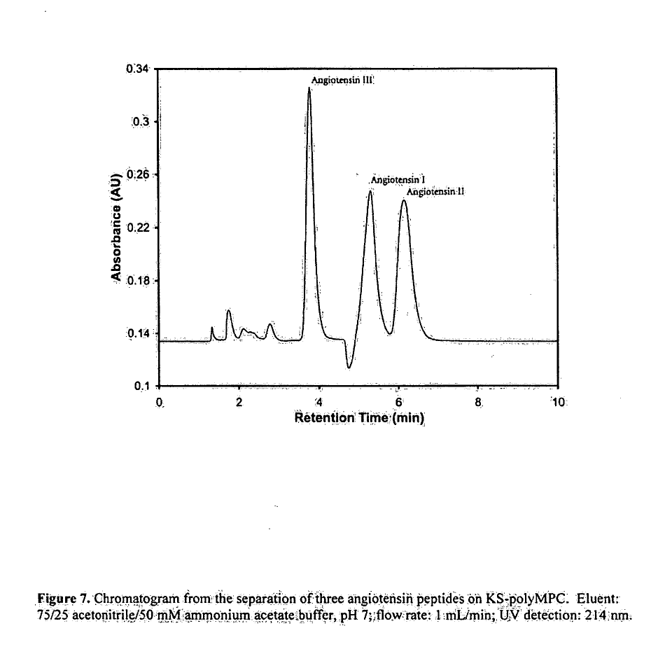

The angiotensins are one of the most important groups of peptides for regulation of the cardiovascular system. Monitoring these peptides is important because many of the metabolized peptide fragments are biologically active, especially angiotensin II, III and IV (Neves, L. A. A.; Almeida, A. P.; Khosla, M. C.; Santos, R. A. S. Biochem. Pharmacol. 1995, 50, 1451-1459). Since these peptides have different biological functions, high performance methods should be established for their purification or quantification. Many separation techniques, e.g. RP-HPLC, cation exchange, hydrophobic interaction, gel permeation chromatography, or capillary electrophoresis, have been applied for the determination of angiotensin peptides (Kobayashi, J.; Kikuchi, A.; Sakai, K.; Okano, T. Anal. Chem. 2003, 75, 3244-3249; Lacher, N. A.; Garrison, K. E.; Lunte, S. M. Electrophoresis 2002, 23, 1577-1584; Balment, R. J.; Warne, J. M.; Takei, Y. Gen. Comp. Endocr. 2003, 130, 92-98). These techniques show different separation efficiencies and selectivities, and RP-HPLC is still the method most commonly used for angiotensin separations. However, RP-HPLC suffers from difficulties of obtaining good resolution between the angiotensins II and III unless buffers containing ion pairing reagents are used (Naik, G. O. A.; Moe, G. W. J. Chromatogr. A 2000, 870, 349-361). Gradient elution and fine adjustment of the trifluoroacetic acid (TFA) concentration is needed (MAC-MOD Analytical Inc., The Benefits of Ultra-Inert Stationary Phases for the Reversed Phase HPLC of Biomolecules; http://www.mac-mod.com/tr/05031-tr.html; refers to page as of 2005-04-16). HILIC is a relatively “new” chromatographic technique, and the separation of angiotensins has, to the best of our knowledge, not yet been presented in this mode. FIG. 7 shows the HILIC separation of the three most important angiotensin peptides on the KS-polyMPC column. The retention order is angiotensin III<angiotensin I<angiotensin II, which is different from that seen in RP-HPLC (normally angiotensin II<angiotensin III<angiotensin I). This altered retention pattern is expected is because retention in HILIC is based on hydrophilicity, as opposite to hydrophobicity in RP-HPLC. The HILIC separation on the KS-polyMPC column therefore provides a unique separation selectivity orthogonal to RP-HPLC, which also can be very useful in multidimensional and coupled column separations.

### Example 7

### Synthesis of KS-PC Zwitterionic Separation Materials by a Multi-Step Synthetic Route

10 g of Kromasil silica (5 μm, 200 Å) was first mixed with 100 ml of dry acetonitrile and 8 ml of triethylamine in a 250 ml three-necked flask, which was then cooled to −20° C. under stirring in a thermostat. A solution of 10 ml of ethylene chlorophosphate in 100 ml dry acetonitrile was slowly added to the above mixture over a period of one hour. The reaction was maintained at −20° C. for another 3 hours after the addition. Whereafter the mixture was filtrated through a 3 Å glass filter, and further washed by 200 ml dry acetonitrile. The filtrated particles were transferred to a 250 ml three-neck glass flask with 150 ml of dry acetonitrile, where a dry ice condenser was mounted in the center neck for refluxing. 10 ml of anhydrous Trimethylamine were then rapidly added to the flask through a side neck. The glass flask was immersed into a 60° C. thermostat and kept there for 16 hours with the continuous addition of dry ice into the condenser. After reaction, the mixture was cooled down to room temperature, and the mixture was subsequently filtered by a 3 Å glass filter. The filtrated particles were further washed by an order of 200 ml cold acetonitrile-1 liter of 50 mM HCl solutions-200 ml methanol-200 ml acetone-200 ml methanol, in order to obtain clean material suitable for column packing.

### Example 8

### Comparison of the KS-polyMPC Column with a Sulfobetaine Type of Zwitterionic Phase Having its Functional Group Charges Positioned in a Reverse Direction

The six peptides chosen as test probes were used for comparing the KS-polyMPC column with a commercially available sulfobetaine zwitterionic stationary phase having its charges in a reverse direction leaving the negative charge in the end of the ligand. The column used was a ZIC®-HILIC, 5 μm, 200 Å column from SeQuant AB (Umeå, Sweden). The carrier material in this column is also based on Kromasil® silica from EKA Chemicals (Bohus, Sweden). The KS-polyMPC and the ZIC®-HILIC columns were studied with respect to retention factor as function of buffer ion strength and buffer pH values. The eluent was 60% acetonitrile and 40% buffer containing ammonium acetate or for the pH experiments either ammonium acetate or formiate (pH 3 and pH 4 experiments) at a final buffer concentration of 4 mM. The flow rate was 1 mL/min and the peptides were detected at 214 nm by the spectrofotometer.

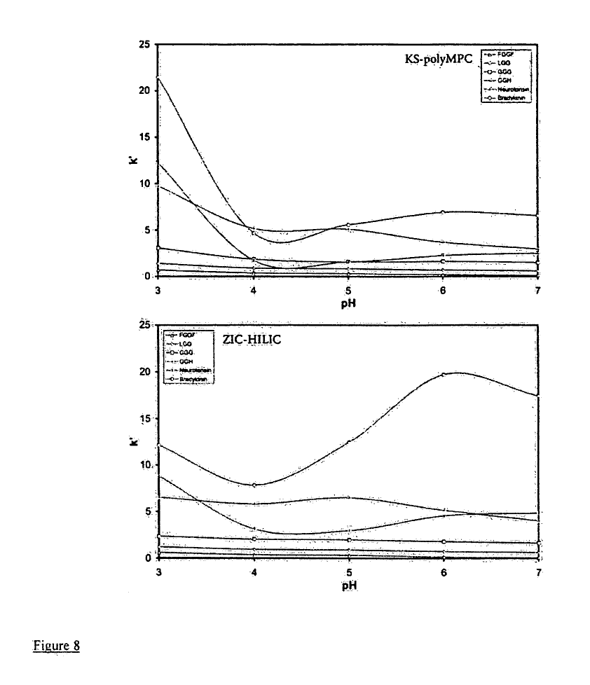

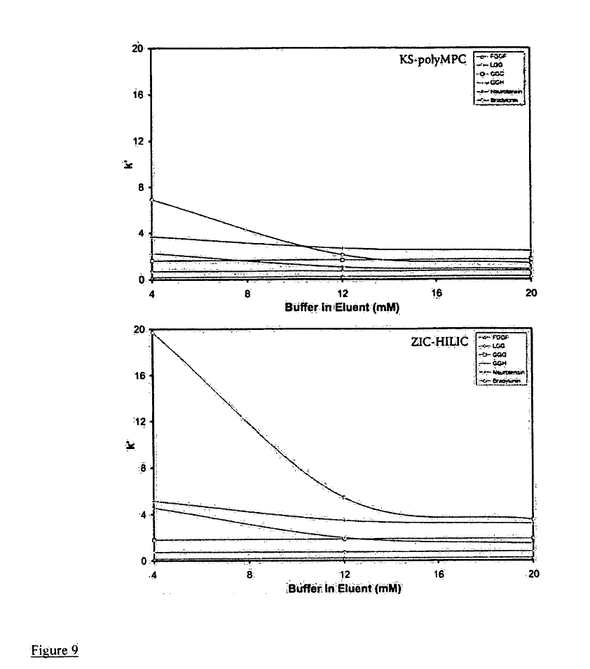

As seen in FIG. 8 the two columns showed comparable retention factors for the slightly acidic peptides FGGF, LGG, and GGG, while the retention for the basic peptides was generally lower on the KS-polyMPC column in the pH range 4 to 7. However, at pH 3 the KS-polyMPC column showed the strongest retention for the basic peptides. These differences in selectivity between the two columns was most apparent in the pH dependent retention pattern for Bradykinin. An explanation for these differences may be pH induced analyte changes. The increased pH makes Bradykinin more positively charged and it will then also, more strongly, interact by an ion-exchange mechanism with the pending sulfobetaine sulfonic acid groups of the ZIC®-HILIC column, while the KS-polyMPC pendant positive charges are expected to repel the analyte leading to less retention. The retention on the KS-polyMPC column showed low dependence with the ion strength in the eluent, see FIG. 9. This behavior was most apparent for the basic peptides, while the sulfobetaine column required nearly twice as much salt for the elution of Bradykinin. This suggests that the KS-polyMPC column is even more suitable for LC-MS electrospray detection where low buffer salt concentration levels are preferred for optimised detectability. The experiments verified that the both zwitterionic phases showed complementary properties with respect to chromatographic selectivity, but still being highly suitable for use in HILIC.

### Example 9

### Complementary Selectivity Using KS-polyMPC Column Compared to a Separation on a Reversed Phase Column

HILIC and reversed phase LC are the orthogonal chromatographic separation techniques, which have shown a greater orthogonality for peptide separation compared to other 2D-LC systems (M. Gilar, P. Olivova, A. E. Daly, J. C. Gebler, Anal. Chem. 2005, 77 6426-6434.)

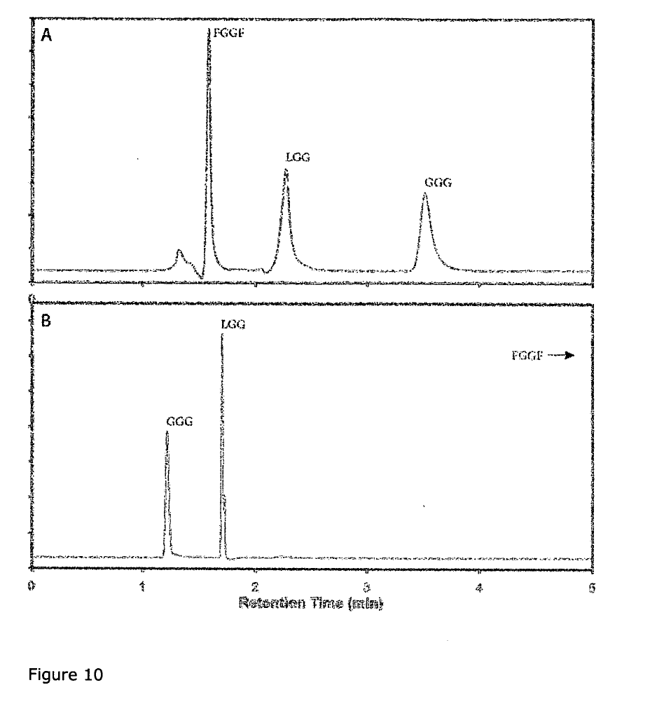

The separation of three small peptides (GGG, LGG and FGGF) was thus compared using a polyMPC in HILIC mode and a Kromasil reversed phase column to study the selectivity using these two chromatographic separation modes. It can be seen in FIG. 10, that the elution order of these three peptides was ortogonal and that the FGGF can not be eluted within 5 minutes using on the reversed phase column at chosen separation conditions.

1. A zwitterionic stationary phase comprising a carrier and at least one zwitterionic ligand bound to said carrier, said phase being suitable for HPLC separation in Hydrophilic Interaction mode, wherein the positively charged part of said zwitterionic ligand is located at the end of the ligand, and the negatively charged part of said zwitterionic ligand is located between the positively charged part and the part of said zwitterionic ligand directly binding to said carrier, characterized in that the intramolecular distance between the negatively charged part of the zwitterionic ligand and the carrier is at most 10 atoms long.

2. A zwitterionic stationary phase according to claim 1, characterized in a that zwitterionic compound according to the general formula
X—R₁—O—PO₂⁻—O—R₂—N⁺R₃R₄R₅
wherein
X is CH₂═C(CH₃)CO—O—, CH₂═CH—CO—O—, CH₂═C(CH₃)CO—N—, CH₂═CH—CO—N—, CH₂═CH—, or CH₂═CH—C₆H₆—;
R₁ and R₂ are the same or different according to the formula —(CH₂)ₙ—, wherein n is chosen from the group of 0, 1, 2, 3 and 4; and
R₃, R₄, and R₅ are the same or different according to the formula —(CH₂)ₙ—Y, wherein n is chosen from the group of 0, 1, 2, 3, and 4, and Y is H or OH,
has been bound by stepwise surface modification onto said carrier.

3. A zwitterionic stationary phase according to claim 2, characterized in that said zwitterionic compound is chosen from the group of 2-(methacryloyloxy)ethyl-2-(trimethylammonium)ethyl phosphate, 2-(methacryloyloxy)-2-[(dimetoxy)methylammonium]ethyl phosphate, 2-(methacryloyloxy)-2-(trimetoxyammonium)ethyl phosphate, 2-(methacryloyloxy)-2-[(2-hydroxyethyl)dimethylammonium]ethyl phosphate,2-(methacryloyloxy)-2-[bis(2-hydroxyethyl)methylammonium]ethyl phosphate, 2-(methacryloyloxy)-2-[tris-(2-hydroxyethyl)ammonium]ethyl phosphate, 2-(p-methacryloyloxybenzoyloxy)ethyl-2-(trimethylammonium)ethyl phosphate, 2-(acryloyloxy)ethyl-2-(trimethylammonium)ethyl phosphate, p-vinylbenzyl-2-(trimethylammonium)ethyl phosphate, p-vinylbenzyl-2-(trimethoxyammonium)ethyl phosphate, and p-vinylbenzyl-2-[tris-(2-hydroxyethyl)ammonium]ethyl phosphate.

4. A zwitterionic stationary phase according to claim 1, characterized in that said carrier is porous silica, zirconium, graphite, or a polymer or copolymer material in the shape of spherical particles having a size ranging from 0.1 to 100 μm and a porosity from 50 to 1000 Å, or a monolithic structure of said materials, or alternatively the inner-walls of a narrow bore fused silica capillary.

5. A zwitterionic stationary phase comprising a carrier and at least one zwitterionic ligand bound to said carrier, said phase being suitable for HPLC separation in Hydrophilic Interaction mode, wherein the positively charged part of said zwitterionic ligand is located at the end of the ligand, and the negatively charged part of said zwitterionic ligand is located between the positively charged part and the part of said zwitterionic ligand directly binding to a polymeric backbone attached to the carrier, characterized in that the zwitterionic ligand has been bound to said carrier by graft polymerization of zwittionic monomers onto the surface of said carrier.

6. A zwitterionic stationary phase according to claim 5, characterized in that the intramolecular distance between the negatively charged part of the zwitterionic ligand and the polymeric backbone is at most 10 atoms long.

7. A zwitterionic stationary phase according to claim 5, characterized in that said carrier is porous silica, zirconium, graphite, or a polymer or copolymer material in the shape of spherical particles having a size ranging from 0.1 to 100 μm and a porosity from 50 to 1000 Å, or a monolithic structure of said materials, or alternatively the inner-walls of a narrow bore fused silica capillary.

8. A zwitterionic stationary phase according to claim 5, characterized in that a zwitterionic monomer according to the general formula
X—R₁—O—PO₂⁻—O—R₂—N⁺R₃R₄R₅
wherein
X is CH₂═C(CH₃)CO—O—, CH₂═CH—CO—O—, CH₂═C(CH₃)CO—N—, CH₂═CH—CO—N—, CH₂═CH—, or CH₂═CH—C₆H₆—;
R₁ and R₂ are the same or different according to the formula —(CH₂)ₙ—, wherein n is chosen from the group of 0, 1, 2, 3 and 4; and
R₃, R₄, and R₅ are the same or different according to the formula —(CH₂)ₙ—Y, wherein n is chosen from the group of 0, 1, 2, 3, and 4, and Y is H or OH, has been graft polymerized onto said carrier.

9. A zwitterionic stationary phase according to claim 8, characterized in that said zwitterionic monomer is chosen from the group of 2-(methacryloyloxy)ethyl-2-(trimethylammonium)ethyl phosphate, 2-(methacryloyloxy)-2-[(dimetoxy)methylammonium]ethyl phosphate, 2-(methacryloyloxy)-2-(trimetoxyammonium)ethyl phosphate, 2-(methacryloyloxy)-2-[(2-hydroxyethyl)dimethylammonium]ethyl phosphate,2-(methacryloyloxy)-2-[bis(2-hydroxyethyl)methylammonium]ethyl phosphate, 2-(methacryloyloxy)-2-[tris-(2-hydroxyethyl)ammonium]ethyl phosphate, 2-(p-methacryloyloxybenzoyloxy)ethyl-2-(trimethylammonium)ethyl phosphate, 2-(acryloyloxy)ethyl-2-(trimethylammonium)ethyl phosphate, p-vinylbenzyl-2-(trimethylammonium)ethyl phosphate, p-vinylbenzyl-2-(trimethoxyammonium)ethyl phosphate, and p-vinylbenzyl-2-[tris-(2-hydroxyethyl)ammonium]ethyl phosphate.

10. A method for preparing a zwitterionic stationary phase according to claim 5, comprising the steps of:
a) providing a carrier, such as a porous silica, zirconium, graphite, or polymer material in the shape of a particle, or a porous monolith, or the inner-walls of a narrow bore fused silica capillary;
b) providing a zwitterionic monomer containing a phosphorylcholine zwitterionic functionality;
c) optionally activating the surface of said carrier;
d) optionally providing a polymerization catalyst;
e) contacting said optionally activated carrier, said zwitterionic monomer, and optionally said catalyst, thereby initiating a polymerization process on the surface of said carrier; and thereby
f) obtaining said zwitterionic stationary phase according to claim 5.

11. Use of a zwitterionic stationary phase according to claim 1 in HPLC separation methods.

12. A chromatography column comprising a stationary phase according to claim 1.
